(19) United States
(12) Patent Application Publication
(10) Pub. No.: US 2009/0140112 A1
(43) Pub. Date: Jun. 4, 2009

(54) Dual T-slot adaptor

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/998,699

(22) Filed: Nov. 30, 2007

(51) Int. Cl. F16M 11/14

(52) U.S. Cl. 248/223.41; 248/276.1; 248/288.31

(57) ABSTRACT

A quick release T-slot adaptor having a substantially rigid adaptor base plate formed with first and second substantially planar and parallel spaced apart opposing surfaces, and a substantially rigid T-slot connector incorporated in the adaptor base plate. The T-slot connector includes a hook plate spaced away from the first surface of the adaptor base plate and substantially parallel therewith, a stop plate extended substantially perpendicularly between the hook plate and the first surface of the adaptor base plate, and a guide plate positioned substantially central of the hook plate substantially perpendicular to the stop plate and extended substantially perpendicularly between the hook plate and the first surface of the adaptor base plate. The quick release T-slot adaptor also includes a plurality of quick release connectors provided on the second surface of the adaptor base plate opposite from the T-slot connector.

### FIELD OF THE INVENTION

The present invention relates generally to adapters for T-slot connector plates, and in particular to T-slot adapters for converting alternative mounting apparatus to T-slot mounts.

### BACKGROUND OF THE INVENTION

T-slot connector plates and mating T-slot adaptors are generally well-known for temporary mounting of cellular telephone, satellite radio and other portable electronic devices to T-slot mounting apparatus on building walls and in automobiles as well as other vehicles.

FIG. 1 illustrates one embodiment of a T-slot connector plate 1 incorporated into a cradle 3 for mounting a portable or cellular telephone, satellite radio or another portable electronic device. As illustrated here, the T-slot connector plate may include more than one T-slot. For example, two T-slots, as shown, form a dual T-slot connector plate 1. As illustrated here, the female T-slot connector plate 1 is formed with a T-slot 4 having a large substantially rectangular aperture 5 through an interface surface 6, with a channel portion 7 extending from one edge 9 and communicating with the aperture 5. The rectangular aperture 5 and channel portion 7 extending therefrom respectively receive and releasably capture a mating portion of the T-slot adaptor.

However, known T-slot adaptors are generally permanently mounted, e.g. screwed or otherwise attached to a wall or other vehicle surface. Known T-slot adaptors are thus limited in their ability to provide efficient and reliable expansion capability for combining in a chain with other mounting devices.

### SUMMARY OF THE INVENTION

The present invention is a novel quick release T-slot adaptor for operation with a quick release T-slot connector plate of known design. The known permanently mounted quick release T-slot connector plate is incorporated into a cradle or other mounting structure for mounting a portable or cellular telephone, satellite radio or another portable electronic device.

According to one aspect of the invention the novel quick release T-slot adaptor includes a substantially rigid adaptor base plate having first and second substantially planar and parallel spaced apart opposing surfaces, and a substantially rigid T-slot connector incorporated in the adaptor base plate. By example and without limitation, the T-slot connector includes a hook plate spaced away from the first surface of the adaptor base plate and substantially parallel therewith, a stop plate extended substantially perpendicularly between the hook plate and the first surface of the adaptor base plate, and a guide plate positioned substantially central of the hook plate substantially perpendicular to the stop plate and extended substantially perpendicularly between the hook plate and the first surface of the adaptor base plate. The novel quick release T-slot adaptor also includes a plurality of quick release connectors provided on the second surface of the adaptor base plate opposite from the T-slot connector.

According to another aspect of the novel quick release T-slot adaptor, the connector means further includes a plurality of quick release connectors substantially uniformly distributed relative to the second surface of the adaptor base plate.

According to another aspect of the novel quick release T-slot adaptor, the quick release connectors are further extended from the second surface of the adaptor base plate.

According to another aspect of the novel quick release T-slot adaptor, each of the quick release connectors is further configured as a split bullet nose connector.

According to another aspect of the novel quick release T-slot adaptor, each of the quick release connectors is further configured as a bullet nose extended from the second surface of the adaptor base plate on a trunk, and a slot substantially bisecting the bullet nose and at least partially substantially bisecting the trunk.

According to another aspect of the novel quick release T-slot adaptor, a connecting mounting device is included therein. By example and without limitation, the connecting mounting device includes a substantially rigid base plate having a first substantially planar mounting surface and a radially compressible ball portion of a ball-and-socket connector extended from a second surface of the base plate opposite from the first surface on a substantially rigid stem of smaller diameter than the ball portion, and the base plate is formed with a plurality of apertures structured to cooperate with the split bullet nose connectors with at least a portion of the plurality of apertures being positioned to receive one of the split bullet nose connectors therethrough.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates one embodiment of a T-slot connector plate of the prior art being incorporated into a cradle for mounting a portable or cellular telephone, satellite radio or another portable electronic device;

FIG. 2 is a perspective view that illustrates the invention embodied by example and without limitation as a novel quick release T-slot adaptor;

FIG. 3 is a perspective view that illustrates an external mounting device connected to an adaptor base plate portion of the novel quick release T-slot adaptor and having a plurality of quick release connectors;

FIG. 4 is a side view showing the mounting device connected the adaptor base plate of the novel quick release T-slot adaptor using the plurality of quick release connectors;

FIG. 5 is an end view showing the mounting device connected the adaptor base plate of the novel quick release T-slot adaptor using the plurality of quick release connectors;

FIG. 6 is an isometric view that shows one exemplary embodiment of the novel quick release T-slot adaptor;

FIG. 7 is a view of the novel quick release T-slot adaptor that illustrates a second surface of the adaptor base plate;

FIGS. 8 and 9 are respective side elevation and cross-section views of the novel quick release T-slot adaptor; and

FIGS. 10 and 11 are respective end elevation and cross-section views of the novel quick release T-slot adaptor.

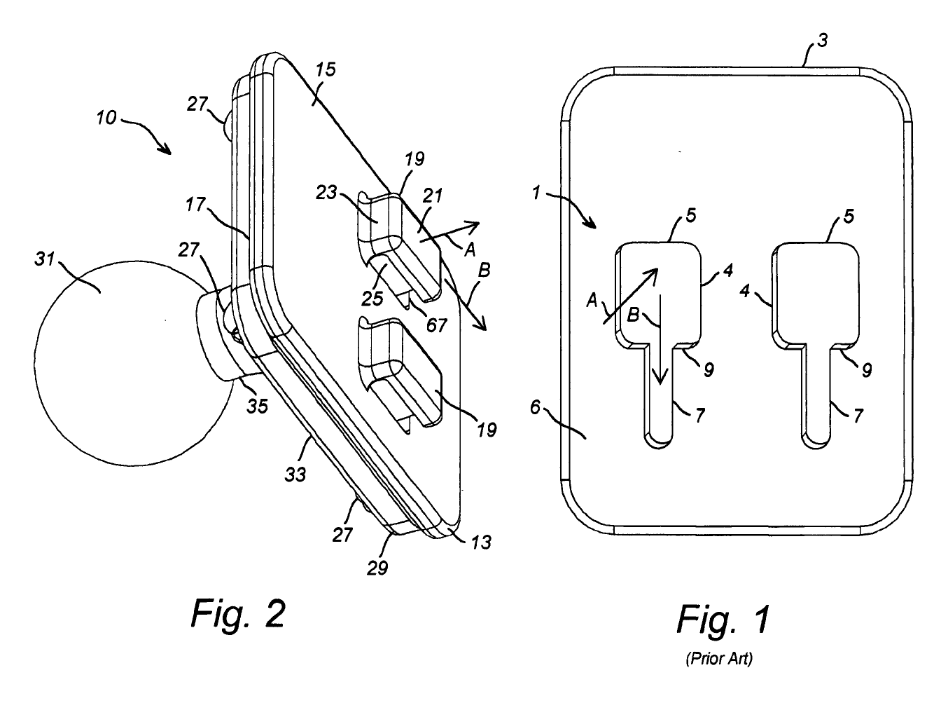

### DETAILED DESCRIPTION OF PREFERRED EMBODIMENT

In the Figures, like numerals indicate like elements.

FIG. 2 is a perspective view that illustrates the invention embodied by example and without limitation as a novel quick release T-slot adaptor 10. As illustrated here, the quick release T-slot adaptor 10 includes a substantially rigid adaptor base plate 13 having first and second substantially planar and parallel spaced apart opposing surfaces 15 and 17. For example, the adaptor base plate 13 is optionally formed of a substantially rigid material, including but not limited to, an injection molded plastic or metal material. The T-slot adaptor 10 is formed with one or more substantially rigid T-slot connectors 19 entirely integral with the adaptor base plate 13. As illustrated here, the T-slot adaptor 10 includes two of the entirely integral T-slot connectors 19. The T-slot adaptor 10 illustrated thus forms a dual T-slot adaptor operable with a mating dual T-slot connector plate 1 of the prior art.

As more clearly illustrated in subsequent figures, each of the one or more T-slot connectors 19 includes a hook plate 21 spaced away from the first surface 15 of the adaptor base plate 13 and formed substantially parallel therewith. A substantially rigid stop plate 23 is extended substantially perpendicularly between the hook plate 21 and the first surface 15 of the adaptor base plate 13. A substantially rigid guide plate 25 is positioned substantially central of the hook plate 21 and extended substantially perpendicularly between the hook plate 21 and the first surface 15 of the adaptor base plate 13. The guide plate 25 is further formed substantially perpendicular to the stop plate 23.

As illustrated by respective arrows A and B, the male T-slot adaptor 10 is connected to the female T-slot connector plate 1 as follows. As illustrated by arrow A, with the stop plate 23 opposite from the channel portion 7 of the T-slot 4 and the guide plate 25 adjacent thereto, the hook plate 21 of the T-slot connector 19 is inserted into the female aperture 5 until the first surface 15 of the adaptor base plate 13 is substantially seated against the interface surface 6. The guide plate 25 of the T-slot connector 19 is thereby substantially aligned with the channel portion 7 of the T-slot 4. Thereafter, as illustrated by arrow B, the entire T-slot adaptor 10 is moved relative to the T-slot connector plate 1, with the first surface 15 of the adaptor base plate 13 sliding along the interface surface 6 of the female T-slot connector plate 1 in the direction of the channel portion 7. The guide plate 25 of the T-slot connector 19 is slipped into the mating channel portion 7 until the stop plate 23 encounters the edge 9 of the aperture 5, whereby the hook plate 21 is captured behind the interface surface 6 with portions of the T-slot connector plate 1 inserted between the adaptor base plate 13 of the T-slot adaptor 10 and its spaced-away hook plate 21.

The T-slot adaptor 10 also includes one or more quick release connectors 27 integrated with the second surface 17 of the adaptor base plate 13 opposite from the T-slot connectors 19. By example and without limitation, a plurality of the quick release connectors 27 is illustrated here as connecting an external mounting device 29 to the second surface 17 of the adaptor base plate 13. The mounting device 29 is illustrated here by example and without limitation as a ball-and-socket coupler of the type disclosed by example and without limitation in U.S. Pat. No. 5,845,885, “Universally Positionable Mounting Device” issued to the inventor of the present invention on Dec. 8, 1998, which is incorporated herein by reference. Accordingly, the mounting device 29 includes a radially compressible ball portion 31 formed of a resiliently deformable material such as a nitrile rubber material. The ball portion 31 of such a ball-and-socket coupler-type mounting device 29 is extended from a substantially rigid base plate 33 on a substantially rigid stem or neck 35 of smaller diameter than the ball portion 31.

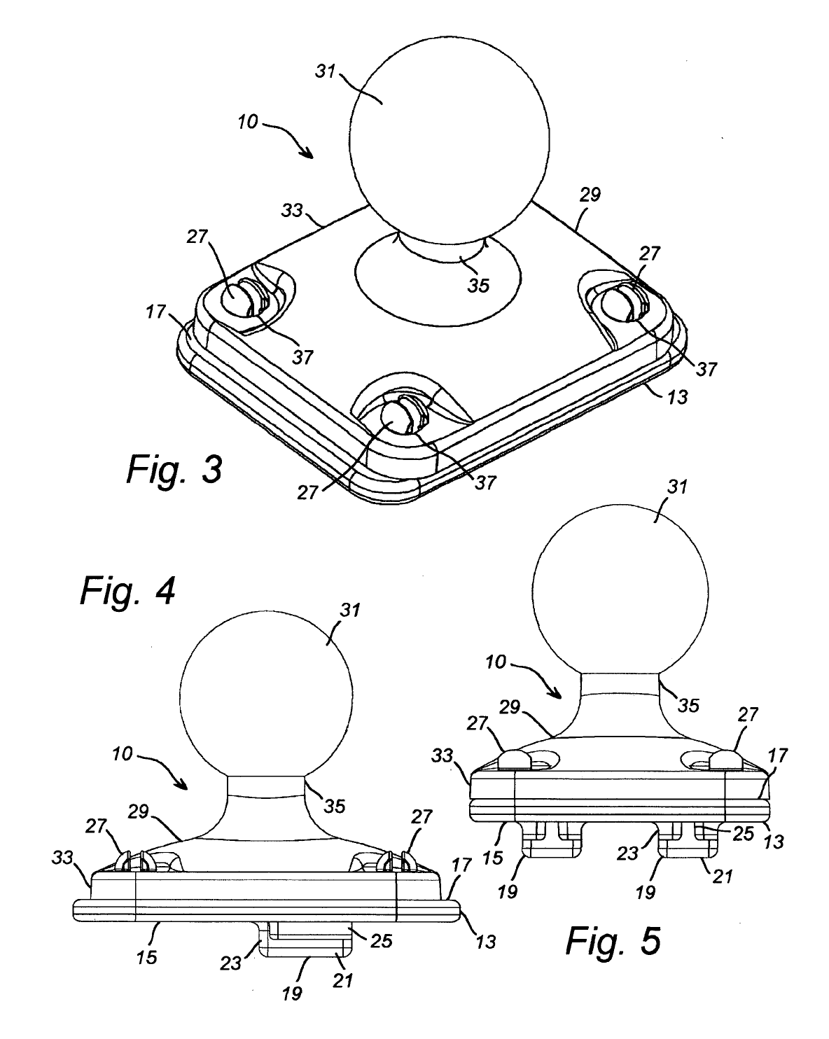

FIG. 3 is a perspective view that illustrates the external mounting device 29 connected to the second surface 17 of the adaptor base plate 13 with the plurality of quick release connectors 27. As illustrated here, each of the quick release connectors 27 inserts through an aperture 37 in the base plate 33 of the mounting device 29 for connecting it to the second surface 17 of the T-slot adaptor's adaptor base plate 13 in a quick release fashion.

FIG. 4 is a side view showing the external mounting device 29 connected the adaptor base plate 13 with the plurality of quick release connectors 27. As illustrated here and in the end view of FIG. 5, in addition to connecting the mounting device 29 to the adaptor base plate 13, the plurality of quick release connectors 27 firmly seat the base plate 33 of the mounting device 29 against the second surface 17 of the adaptor base plate 13.

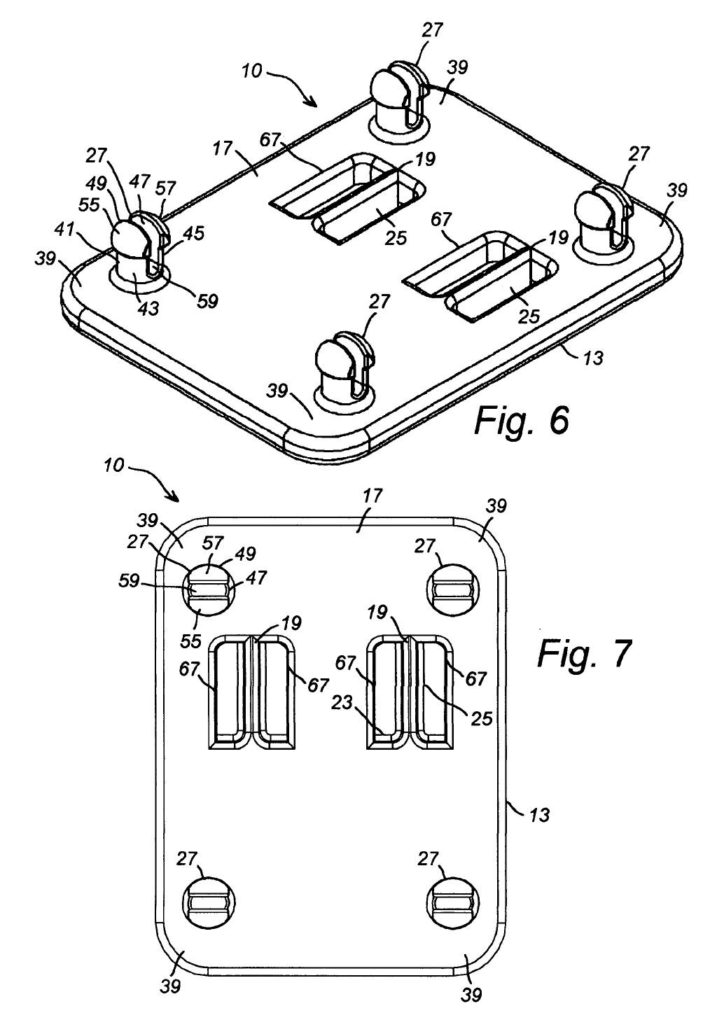

FIG. 6 is an isometric view that shows one exemplary embodiment of the T-slot adaptor 10 illustrated here by example and without limitation as being a dual T-slot adaptor having two of the integral T-slot connectors 19 positioned side-by-side in a substantially symmetrical relationship with respect to the adaptor base plate 13. Here, the adaptor base plate 13 is illustrated by example and without limitation as being substantially rectangular in shape with four of the quick release connectors 27, one in each corner 39 of the adaptor base plate 13.

As illustrated here by example and without limitation, the quick release connectors 27 are bullet nose connectors that are slotted for resilient compressibility. For example, when embodied as bullet nose connectors, the connectors 27 are formed with split or slotted trunks 41 each topped with a split bullet nose 49 spaced away from the second surface 17 of the adaptor base plate 13 opposite from the T-slot connectors 19. The bullet noses 39 of the respective quick release connectors 27 are oversized relative to the apertures 37 in the base plate 33 of the mounting device 29, while the trunks 41 are sized to fit substantially snuggly within the apertures 37 and are of a length selected to space the bullet noses 39 away from the adaptor base plate 13 sufficiently to fit the base plate 33 of the mounting device 29 therebetween.

Each trunk 41 has a pair of substantially identical stems 43, 45 that are substantially symmetrically spaced apart by a longitudinal slot 47 extending nearly to the adaptor base plate 13. The slot 47 extends through the bullet nose 49, thereby dividing it into a pair of substantially identical bullet nose portions 55, 57 that are substantially symmetrically spaced apart by the longitudinal slot 47. The slot 47 permits the stems 43, 45 of the trunk 41 to resiliently bend inward toward one another, which bending also permits the spaced-apart nose portions 55, 57 of the bullet nose 49 to move toward one another when the aperture 37 in the base plate 33 of the mounting device 29 is pressed over it. As the aperture 37 is pressed substantially simultaneously over each of the bullet nose connectors 27, a curved contour of the bullet nose 49 cooperates with the aperture 37 to compress the nose portions 55, 57 across the intervening slot 47 from their normally spaced apart positions, such compressing of the nose portions 55, 57 being aided by resilient bending of the stem portions 43, 45 of the trunk 41 of the respective quick release connectors 27. When the base plate 33 of the mounting device 29 is seated against the second surface 17 of the adaptor base plate 13 of the T-slot adaptor 10, the bullet noses 39 of the respective quick release connectors 27 effectively clear and “pop” out of the apertures 37. The bent stem portions 43, 45 of the respective trunks 41 resiliently straighten to their normally spaced apart positions, whereby the compressed nose portions 55, 57 uncompress and spread apart to their normally spaced apart positions. The relatively oversized bullet noses 39 of the respective quick release connectors 27 effectively capture the base plate 33 of the mounting device 29 snuggly against the second surface 17 of the adaptor base plate 13 of the T-slot adaptor 10, as illustrated in previous figures.

FIG. 7 is a view of the T-slot adaptor 10 showing the second surface 17 of the adaptor base plate 13. The quick release connectors 27 are shown as projecting from the second surface 17 of the adaptor base plate 13 and being substantially uniformly distributed adjacent to respective corners 39 thereof, and the pair of T-slot connectors 19 are shown as projecting away from the first surface 15.

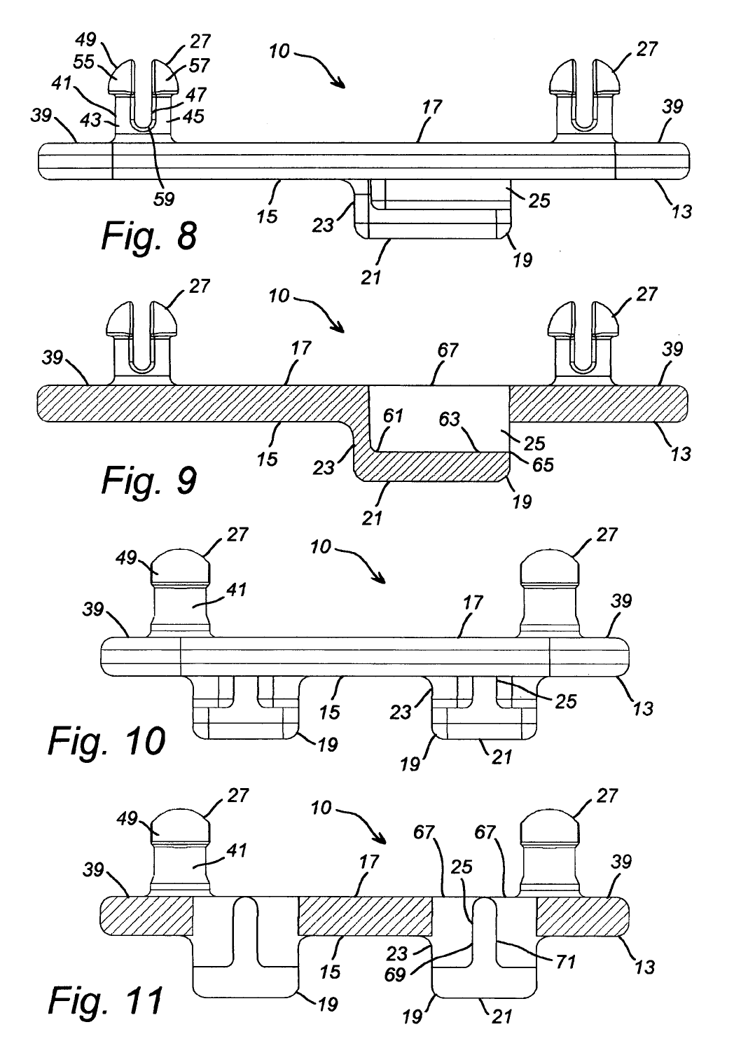

FIGS. 8 and 9 are side elevation and cross-section views, respectively, of the T-slot adaptor 10 that more clearly show the details of the T-slot connectors 19 and quick release connectors 27 as discussed herein. As detailed here, the substantially longitudinal slots 47 in the respective quick release connectors 27 substantially bisect the trunk 41 and bullet nose 49 portions into respective spaced apart stem portions 43, 45 and nose portions 55, 57. The slots 47 extend nearly to the second surface 17 of the adaptor base plate 13 and terminate in curved throat portions 59 that operate as stress relief's to avoid damaging the trunk 41 otherwise caused by resilient bending together of the spaced apart stem portions 43, 45 during insertion of the bullet nose 49 into the aperture 37.

The hook plate 21 of the T-slot connector 19 is more clearly shown as being spaced away from the first surface 15 of the adaptor base plate 13 and formed substantially parallel therewith. The stop plate 23 is more clearly shown as being extended substantially perpendicularly between an inside edge 61 of the hook plate 21 and the first surface 15 of the adaptor base plate 13, with the guide plate 25 being extended from of the stop plate 23 along an inner surface 63 of the hook plate 21 and terminating at an outer edge 65 thereof opposite from the stop plate 23.

FIGS. 10 and 11 are end elevation and cross-section views, respectively, of the T-slot adaptor 10 that more clearly show the details of the T-slot connectors 19 and quick release connectors 27 as discussed herein. As detailed here, slots or other apertures 67 are optionally formed through the adaptor base plate 13 in alignment with the hook plate 21 of the T-slot connector 19 and extending on opposite sides 69, 71 of the guide plate 25 to ease manufacturing of the T-slot adaptor 10, for example, by injection molding.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A quick release T-slot adaptor, comprising:
a substantially rigid adaptor base plate;
a substantially rigid T-slot connector incorporated in the adaptor base plate and extending from a first surface thereof; and
a quick release connector provided on a second surface of the adaptor base plate opposite from the T-slot connector.

2. The adaptor of claim 1, further comprising a plurality of quick release connectors each provided on the second surface of the adaptor base plate.

3. The adaptor of claim 2 wherein the plurality of quick release connectors are further substantially uniformly distributed relative to the second surface of the adaptor base plate.

4. The adaptor of claim 1 wherein the quick release connector is further extended from the second surface of the adaptor base plate.

5. The adaptor of claim 4 wherein the quick release connector further comprises a split bullet nose connector.

6. The adaptor of claim 5 wherein the split bullet nose connector further comprises a pair of spaced apart opposing partial bullet nose portions extended from the second surface of the adaptor base plate on respective spaced apart substantially resiliently flexible partial trunk portions.

7. The adaptor of claim 5, further comprising a connecting mounting device comprising a substantially rigid base plate formed with an aperture structured to cooperate with the split bullet nose connector.

8. A quick release T-slot adaptor, comprising:
a substantially rigid adaptor base plate;
a substantially rigid T-slot connector incorporated in the adaptor base plate and extending from a first surface thereof; and
connector means provided on a second surface of the adaptor base plate opposite from the T-slot connector, the connector means being structured for quickly receiving and releasing a connecting mounting device relative to the second surface of the adaptor base plate.

9. The adaptor of claim 8 wherein the connector means further comprises a plurality of quick release connectors each provided on the second surface of the adaptor base plate.

10. The adaptor of claim 9 wherein the plurality of quick release connectors are further substantially uniformly distributed relative to the second surface of the adaptor base plate.

11. The adaptor of claim 10 wherein the quick release connectors are further extended from the second surface of the adaptor base plate.

12. The adaptor of claim 11 wherein each of the quick release connectors further comprises a split bullet nose connector.

13. The adaptor of claim 12 wherein each of the split bullet nose connectors further comprises a pair of spaced apart opposing partial bullet nose portions extended from the second surface of the adaptor base plate on respective spaced apart substantially resiliently flexible partial trunk portions.

14. The adaptor of claim 13, further comprising a connecting mounting device comprising a substantially rigid base plate formed with a plurality of apertures structured to cooperate with the split bullet nose connectors, at least a portion of the plurality of apertures being positioned to receive one of the split bullet nose connectors.

15. A quick release T-slot adaptor, comprising:
a substantially rigid adaptor base plate having first and second substantially planar and parallel spaced apart opposing surfaces, a substantially rigid T-slot connector incorporated in the adaptor base plate, the T-slot connector having:
a hook plate spaced away from the first surface of the adaptor base plate and substantially parallel therewith,
a stop plate extended substantially perpendicularly between the hook plate and the first surface of the adaptor base plate, and
a guide plate positioned substantially central of the hook plate substantially perpendicular to the stop plate and extended substantially perpendicularly between the hook plate and the first surface of the adaptor base plate; and
a plurality of quick release connectors provided on the second surface of the adaptor base plate opposite from the T-slot connector.

16. The adaptor of claim 15 wherein the connector means further comprises a plurality of quick release connectors substantially uniformly distributed relative to the second surface of the adaptor base plate.

17. The adaptor of claim 16 wherein the quick release connectors are further extended from the second surface of the adaptor base plate.

18. The adaptor of claim 17 wherein each of the quick release connectors further comprises a split bullet nose connector.

19. The adaptor of claim 18 wherein each of the quick release connectors further comprises a bullet nose extended from the second surface of the adaptor base plate on a trunk, and a slot substantially bisecting the bullet nose and at least partially substantially bisecting the trunk.

20. The adaptor of claim 19, further comprising a connecting mounting device comprising a substantially rigid base plate having a first substantially planar mounting surface and a radially compressible ball portion of a ball-and-socket connector extended from a second surface of the base plate opposite from the first surface on a substantially rigid stem of smaller diameter than the ball portion, the base plate being formed with a plurality of apertures structured to cooperate with the split bullet nose connectors with at least a portion of the plurality of apertures being positioned to receive one of the split bullet nose connectors therethrough.
